(19) United States
(12) Patent Application Publication
(10) Pub. No.: US 2016/0109943 A1
(43) Pub. Date: Apr. 21, 2016

(54) SYSTEM AND METHOD FOR CONTROLLING VISIBILITY OF A PROXIMITY DISPLAY

(71) Applicant: HONEYWELL INTERNATIONAL INC., Morristown, NJ (US)

(72) Inventors: Brent D. Larson, Phoenix, AZ (US); Frank Cupero, Glendale, AZ (US); Daryl Schuck, Seabrook, TX (US); David J. Dopilka, Glendale, AZ (US)

(73) Assignee: HONEYWELL INTERNATIONAL INC., Morristown, NJ (US)

(21) Appl. No.: 14/519,572

(22) Filed: Oct. 21, 2014

(51) Int. Cl. G06F 3/01; G02B 27/01; G06F 3/14; G02B 27/00

(52) U.S. Cl. CPC G06F 3/013; G02B 27/0093; G02B 27/0101; G06F 3/14; G02B 2027/014; G02B 2027/0138

(57) ABSTRACT

A system and method for controlling a proximity display system by providing the ability to rapidly blank and un-blank the display is provided. The system and method enable modifying, blanking and un-blanking in response to the detected location of the viewer's eye. The system and method optionally provide the viewer with cueing information that directs the viewer's eye toward the eyebox in response to detecting that the viewer's eye is out of the eyebox.

### TECHNICAL FIELD

Embodiments of the subject matter described herein relate generally to display systems and, more particularly, to proximity display systems.

### BACKGROUND

Display systems that are located on a fixed structure near the head of the viewer and provide virtual images, but are not affixed to the head of the viewer, are referred to herein as proximity display systems. Accordingly, proximity display systems include a wide variety of head up displays (HUD), virtual image displays and combiner-based displays but do not include conventionally configured head-mounted displays (HMD), near to eye (NTE) displays or direct-view displays. Further, proximity display systems do not include displays mounted on helmets that are secured to the head in a way that enables the display element to maintain a fixed location with respect to the user's eye as the user's head moves around (this type of helmet-mounted display may be found, for example, on a motorcycle helmet).

One area where proximity display systems can be employed is on protective suits that include a protective structure around the head of the user; examples include space suits, deep sea diving suits, and protective gear used in environmental disposal situations. Generally affixed to the protective structure around the head, the proximity display system produces a virtual image, referred to herein as the “display,” that provides information and/or enables the viewer with a variety of applications.

Protective suits are typically utilized in situations having an especially acute need for providing only needed information while minimizing distraction from tasks at hand. Accordingly, the visibility of the display on a protective suit should not unduly interfere with the visibility of the outside world, or distract the user from activities occurring in the outside viewing area. Situations requiring protective suits often require the wearer to respond to rapidly changing activities and environments, during which time safety and awareness would be improved if the proximity display system provided the ability to rapidly remove (blank) and restore (un-blank) the display. In addition, a proximity display system that simply does not produce a display when it is not needed would increase safety and awareness.

In response to the foregoing, a system and method for controlling a proximity display system by providing the ability to rapidly modify, blank and un-blank the display is desirable. It is also desirable to control modifications, blanking and un-blanking in response to, and indicative of, the detected location of the viewer's eye. It is further desirable to optionally provide the viewer with cueing information that directs the viewer's eye toward the eyebox in response to detecting that the viewer's eye is out of the eyebox.

### BRIEF SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

A proximity display system is provided. The proximity display system comprises a detector for detecting a location of an eye and an image source for generating an image. A processor is coupled to the image source and detector, and is configured to i) determine the location of the eye with respect to a predetermined eyebox, and ii) modify the generated image depending on the detected location of the eye. An optical assembly is oriented to create a virtual image representative of the generated image and viewable from the predetermined eyebox.

Another proximity display system is provided that comprises an image source for generating an image, a lens coupled to the image source and oriented to produce a virtual image representative of the generated image and viewable from a predetermined eyebox, a detector for detecting the location of an eye, and a processor. The processor is coupled to the image source and detector, and configured to i) display the generated image, ii) determine the location of an eye with respect to a predetermined eyebox, and iii) blank the image when the eye is not located within the predetermined eyebox.

A method for controlling a virtual image in a proximity display system is also provided. The method generates an image and displays the virtual image representative of the generated image. The method detects the location of an eye and blanks the generated image in response to determining that the eye is not located within a predetermined eyebox.

Other desirable features will become apparent from the following detailed description and the appended claims, taken in conjunction with the accompanying drawings and this background.

### BRIEF DESCRIPTION OF THE DRAWINGS

A more complete understanding of the subject matter may be derived by referring to the following Detailed Description and Claims when considered in conjunction with the following figures, wherein like reference numerals refer to similar elements throughout the figures, and wherein:

FIG. 1 is a simplified top down illustration of a viewer's head inside a helmet with a proximity display according to an exemplary embodiment;

FIG. 2 is an illustration depicting an optical assembly receiving light rays from an image generating source and providing parallel light rays within a zone referred to as the eyebox, according to an exemplary embodiment;

FIG. 3 is an expanded top down illustration providing additional detail of an exemplary embodiment;

FIG. 4 is an expanded top down illustration providing detail of an exemplary embodiment providing a see-through combiner;

FIG. 5 is an illustration of a display in which the generated image has been blanked and alternate cueing information is displayed in accordance with an exemplary embodiment; and

FIG. 6 is an illustration of a display in which the generated image has been blanked and alternate cueing information is displayed in accordance with an exemplary embodiment.

### DETAILED DESCRIPTION

The following Detailed Description is merely exemplary in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over any other implementations. Furthermore, there is no intention to be bound by any expressed or implied theory presented in the preceding Technical Field, Background, Brief Summary or the following Detailed Description.

For the sake of brevity, conventional techniques related to graphics and image processing, sensors, and other functional aspects of certain systems and subsystems (and the individual operating components thereof) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Techniques and technologies may be described herein in terms of functional and/or logical block components and with reference to symbolic representations of operations, processing tasks, and functions that may be performed by various computing components or devices. Such operations, tasks, and functions are sometimes referred to as being processor-executed, computer-executed, computerized, software-implemented, or computer-implemented. In practice, one or more processor devices can carry out the described operations, tasks, and functions by manipulating electrical signals representing data bits at memory locations in the processor electronics of the display system, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following descriptions may refer to elements or nodes or features being “coupled” together. As used herein, and consistent with the helmet discussion hereinabove, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements, additional intervening elements, devices, features, or components may be present in an embodiment of the depicted subject matter. In addition, certain terminology may also be used in the following description for the purpose of reference only, and thus are not intended to be limiting.

The embodiments described herein are merely examples serving as a guide for implementing the novel systems and methods herein on any proximity display system in any terrestrial, water, hazardous atmosphere, avionics, or astronautics application. It is readily appreciated that proximity display systems may be incorporated into protective suits, and as such, are designed to meet a plurality of environmental and safety standards beyond the scope of the examples presented below. Accordingly, the examples presented herein are intended as non-limiting.

The optical assembly in the embodiments described herein employs a collimating lens; however numerous other optical configurations for generating virtual images are well-known in the art and may be employed. A partial list of alternatives would include flat or curved reflective elements, diffractive elements, Fresnel lenses, holographic elements, and compound systems which combine multiple elements of the same or multiple types. Use of the terms collimating, collimation or collimated herein is assumed to include the presentation of virtual images at infinite distances or conjugate ratios as well as virtual images that appear to be closer than infinity. Virtual image configurations can also include mirrors or beamsplitters which simply fold the optical path from a display, but in either case the virtual images appear further from the eye than the physical distance to the associated image source. As is described in more detail in connection with the exemplary figures below, a collimating lens is typically employed to receive image light rays on an input surface and produce parallel or substantially parallel light rays at an output surface. Collimating optical systems are often characterized in part by the region or volume from which they can be viewed. A term commonly used for this attribute is “eyebox”.

For a given virtual image optical system, the image light rays that are produced may have an associated high performance region, or “sweet spot,” wherein the most optimal image may be viewed with the eye. Outside of that optimal viewing zone, the quality of the produced virtual image may be inferior. Increasing the size of the high performance region, or sweet spot typically increases the size, weight, complexity and/or cost of the optical system and image source. Advantageously, the embodiments introduced herein effectively reduce the eyebox size for a given optical configuration to provide multiple potential benefits. In addition to the increased safety and awareness considerations described previously, the reduced eyebox size can be better matched to the “sweet spot”, if any, of simpler, lighter, more compact and lower cost optical systems. Numerous other advantages can be achieved by the present embodiments, including reduced power consumption and associated heat generation, and reduced amounts of stray light, when the proximity display system is not being viewed.

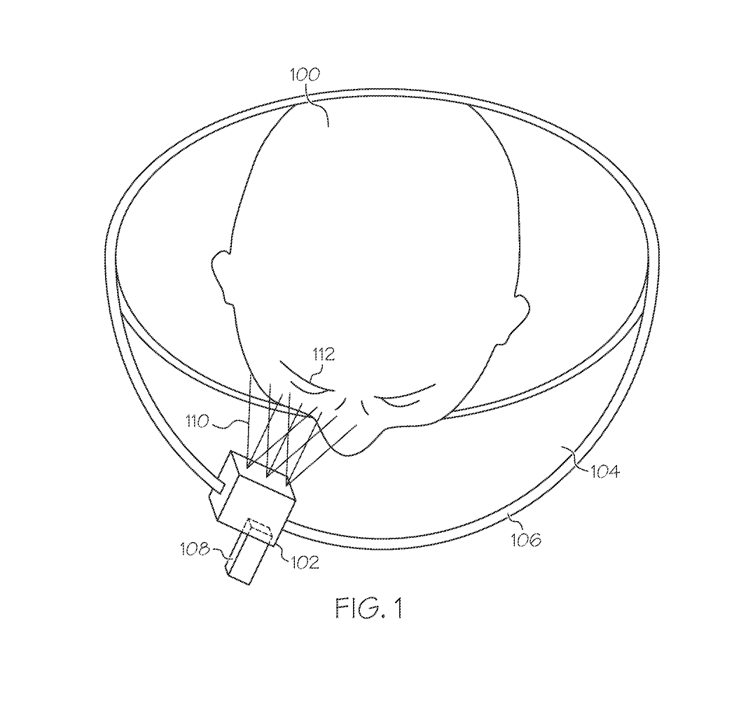

FIG. 1 is a simplified top down illustration of a viewer's head 100 inside a helmet equipped with a proximity display system 102 according to an exemplary embodiment. FIG. 1 is not to scale, but provides an example of the relative placement of features. The viewer's head 100 may be surrounded by a protective bubble 106 supporting, for example, a pressurized oxygen-rich atmosphere 104. Although in practice the protective bubble 106 may comprise multiple layers and various shapes, the illustrated embodiment is simplified and depicts protective bubble 106 as a substantially circular (e.g., spherical or hemispherical) barrier around the viewer's head 100.

An eye detector 108 that may include a camera may be built into the proximity display system 102 or coupled to the proximity display system 102. Eye detection may be performed using various combinations of hardware and software, for example by using currently available iris or pupil detection software. In the exemplary embodiment, the primary objective for eye detector 108 is to determine whether an eye is within a pre-defined eyebox, however, additional optional functionality is supported by the exemplary embodiment. For example, eye detector 108 may be used to determine whether the eye is open or closed, where it is looking, whether it is viewing the virtual image/display, or as an input device between the user and the system. Directed toward the eyebox, image rays 110 produce, from the perspective of the viewer, a virtual image focused at a predetermined distance. The virtual image is often referred to as the “display” or “displayed image.”

The proximity display system 102 may comprise any shape or volume, material, transparency or orientation that is suitable to meet the environmental and design requirements of the application. Additionally, the individual components of the proximity display system 102 may be placed at any location on a helmet or support surface, and may be designed to support variously predetermined eyeboxes, such as by detecting the presence of only the right eye, only the left eye, either eye, or both eyes. In response to detection of the eye in the eyebox, proximity display system 102 produces a virtual image referred to herein as the “display” that may be comfortably viewed from within the predetermined eyebox.

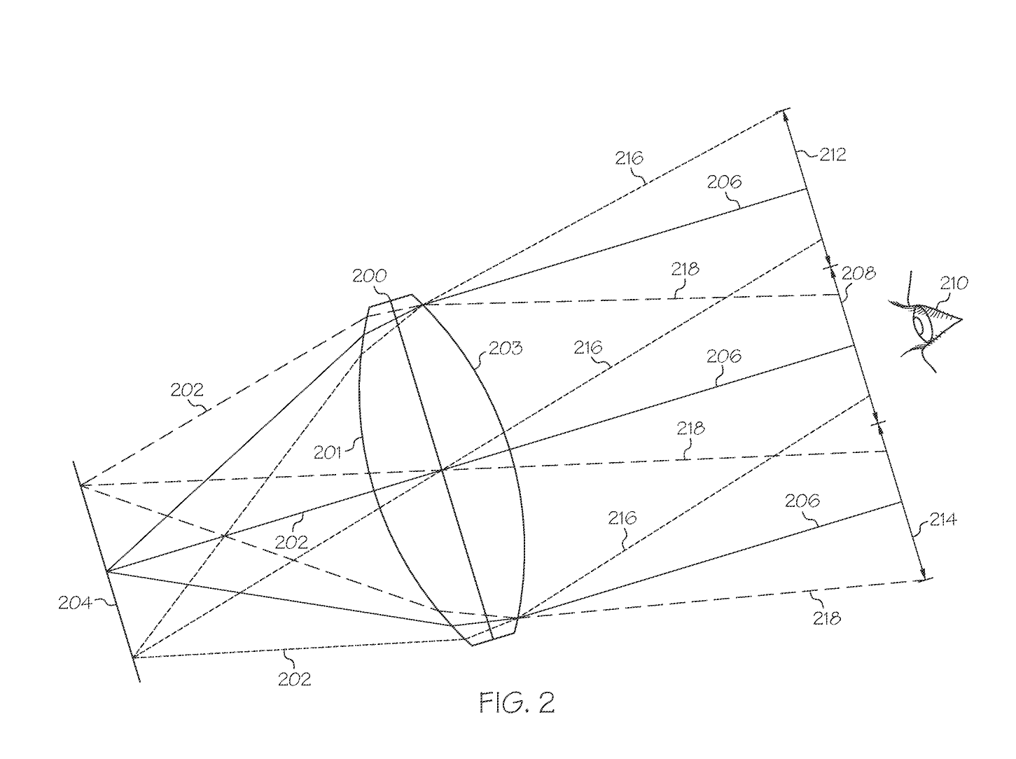

FIG. 2 is a simplified illustration depicting an optical assembly 200 receiving light rays 202 from an image source 204 at an input surface 201 and providing corresponding virtual image (e.g., parallel) light rays 206, 216 and 218 at an output surface 203, according to an exemplary embodiment. The optical assembly in FIG. 2 comprises a collimating lens. As described above, the preferred or predetermined zone for viewing a virtual image is referred to as the eyebox 208. For simplifying purposes, FIG. 2 is a two dimensional depiction of a three dimensional volume; in other words, the light rays 202, parallel light rays 206, 216 and 218, eyebox 208, first zone 212, and second zone 214, are depicted in two dimensions but may make up a three dimensional volume. In the exemplary embodiment, when eye 210 is determined to be within eyebox 208, the image source 204 generates image light rays 202 that are received on input surface 201 of optical assembly 200, and the generated image light rays result in the display of a virtual image (the “display”) that is viewable for the eye 210. Note that different locations on image source 204 correspond with different virtual image points or directions for the resulting viewable light rays 206, 216 and 218.

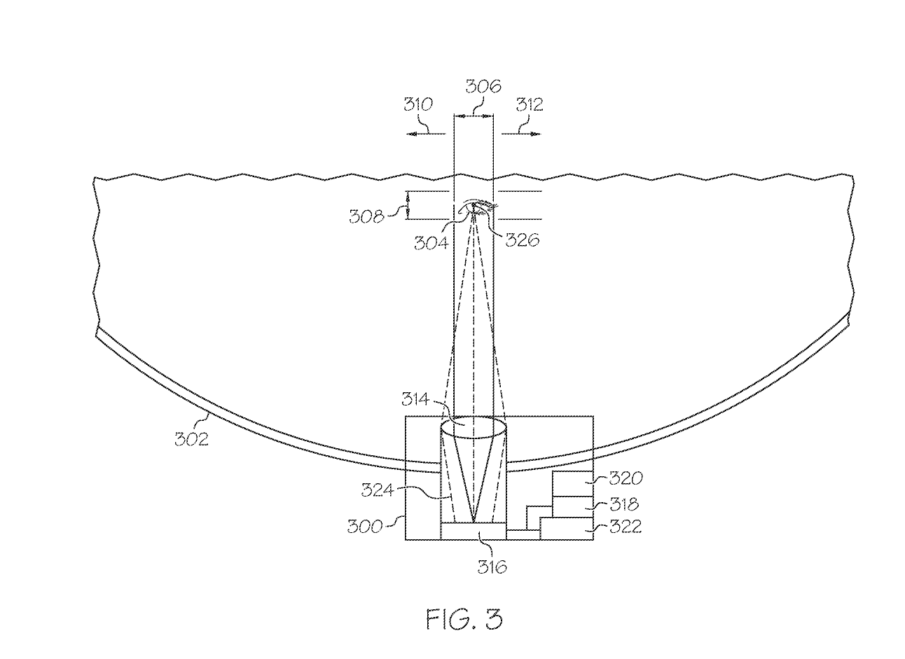

Depending on the location of the eye 210 with respect to the eyebox 208, the exemplary embodiment may modify the generated image. When it is determined that eye 210 is not within eyebox 208 (typically meaning that the user is not viewing the display), the exemplary embodiment may modify (for example, by processor 318 of FIG. 3) the generated image light rays in various ways to serve as a cue to lead the viewer's eye back to eyebox 208. For example, the generated image may be “blanked,” which means that image source 204 does not generate image light rays 202, which results in a blanked virtual image/display.

In another example, with or without blanking the generated image, the processor may modify the generated image by displaying, or adding to the displayed image, cueing symbology that is indicative of the direction that the eye must move to be located within the eyebox 208. Examples of simple and intuitive cueing symbology would include high contrast directional patterns such as spokes, concentric circles or arrows. Further, the exemplary embodiment may determine a direction that the eye must move to be located within the eyebox 208 and modify the generated image by displaying or adding cueing symbology to the displayed image, such as the one or more arrows specifically pointing in the determined direction.

The exemplary embodiment provides other image modification methods intended to alert the viewer that the eye is not within the predetermined eyebox 208, for example by reducing or precluding the visibility of the image. Non-limiting examples include dimming the generated image, dimming the backlight or illuminator (if any) of the image source, reducing the power to the image source, reducing the color gamut of any generated image or symbology (e.g. by changing an image or backlight to green rather than full color), modifying the image sharpness, displaying an intermittent or occasional cueing symbology, or by defining additional zones, some of which provide cueing symbology while others are fully blanked. It should be noted that blanking or otherwise modifying the generated imagery to restrict viewability when the eye is outside predetermined eyebox 208 does not necessarily mean that all portions of the generated image are equally viewable across the full extent of predetermined eyebox 208. For example there may be inherent vignetting of the representation of the generated image near the edges of predetermined eyebox 208.

As described in the context of FIG. 2, eyebox 208 and zones 212, 214 represent spatial regions, but it should be understood that in other embodiments the eyebox and viewing zone definitions can be broadened. The processor (such as processor 318 in FIG. 3) may use eye or pupil detection data provided by the eye detector to determine additional state-of-the-eye features, such as the rate of eye movement, eye acceleration, whether the eye lid is open or closed, and the like. This eye or pupil detection data may be combined by the processor in the determination of commands to the image source, and affect the generation of images and display of modified images during the course of operation of the proximity display system. In addition, the processor (such as processor 318 in FIG. 3) may generate additional system commands in response to the eye/pupil data, including aural annunciators and indicator lights that may not be presented as visual imagery. In an embodiment, the processor may generate system commands to cause aural alerts in response to detecting that the eye has been closed for a predetermined sleep alert time.

The exemplary embodiment may employ programmable or user input data to define the size or other characteristics of eyebox 208 as well as to predefine additional regions of space proximate to eyebox 208, such as a first zone 212, or a second zone 214; in response, the exemplary embodiment may determine whether eye 210 is in any of these predefined regions of space. The exemplary embodiment may additionally assign priorities to the predefined regions of space, or zones, for example, a first priority to the first zone 212 and a second priority to the second zone 214. In response to priorities, the processor (such as processor 318 in FIG. 3) may command system tasks or operations. For example, while an eye positioned in one or more zones outside of eyebox 208 may result in blanking of the image or display of a cueing image as described above, the proximity display system may be configured to override that nominal behavior in the case of alerts or similar contexts. Causal examples include situations in which immediate attention may be required rather than waiting for the eye to return to the eyebox 208, such as equipment failure(s), incoming messages requiring attention, and the like.

FIG. 3 is an expanded top down illustration providing additional detail of an embodiment. Proximity display system 300 is shown coupled to protective bubble 302. Components making up the proximity display system 300 may be internal or external to the protective bubble. An eye 304 (not to scale) is shown within an eyebox defined by length 308 and width 306 (alternatively, the eyebox could be defined by a radius or diameter, or more generally as a volume having a desired form factor). An optionally defined first zone 310 and second zone 312 are shown as regions on the left and right side of the eyebox.

Proximity display system 300 includes collimating lens 314 and an image source 316. An input surface of the collimating lens 314 faces the image source 316, having unobscured access to images generated by the image source 316. Generated image light rays 324 (analogous to image light rays 202 in FIG. 2) are shown impinging on the input surface (such as input surface 201 of FIG. 2) of collimating lens 314; collimating lens 314 deflects the image light rays 324 such that the rays leaving its output surface (such as output surface 203 of FIG. 2) present a virtual image for potential viewing by eye 304 in the predetermined eyebox. The display (displayed virtual image) is a representation of the image generated by the image source 316, and is viewable by eye 304 from a nominal or optimum viewing point 326.

The display appears to be focused at a predetermined distance that is greater than the physical distance from the eye 304 to the image source 316 and may meet any design criteria, generally selected to minimize eye strain or adjustment on the part of the viewer. In some embodiments, the predetermined distance appears to be from about five feet away from the viewer to infinity. In other embodiments, the predetermined distance might correspond with arms-length viewing. While the collimating lens 314 is depicted in FIG. 3 as a single lens, it may include a plurality of optical elements of various types, sizes, and shapes, for example lenses, mirrors, holograms, prisms, beamsplitters, waveguides, etc. as known in the art.

Processor 318 receives data and instructions from memory 320 and eye detector 322 and, in response, determines commands and input for image source 316. Optionally, one or more user input devices may also be coupled to the processor 318 to allow user modification of parameters such as zone identification, zone and eyebox dimensions, and zone priorities. Depending upon user input devices employed, optional user input may be verbal, textual, touch or gesture commands as well as the mechanical manipulation of keys or buttons. As previously stated, eye detector 322 may include a camera which may be built into the proximity display or coupled to the proximity display. Eye detection may be performed using various combinations of known or currently available hardware and software, for example by using iris detection software.

The processor 318 may be implemented or realized with at least one general purpose processor device, a content addressable memory, a digital signal processor, an application specific integrated circuit, a field programmable gate array, any suitable programmable logic device, discrete gate or transistor logic, discrete hardware components, or any combination designed to perform the functions described herein. A processor device may be realized as a microprocessor, a controller, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration. As described in more detail below, the processor 318 is configured to command the display functions of the image source 316, and may be in communication with various electronic systems included in the protective suit.

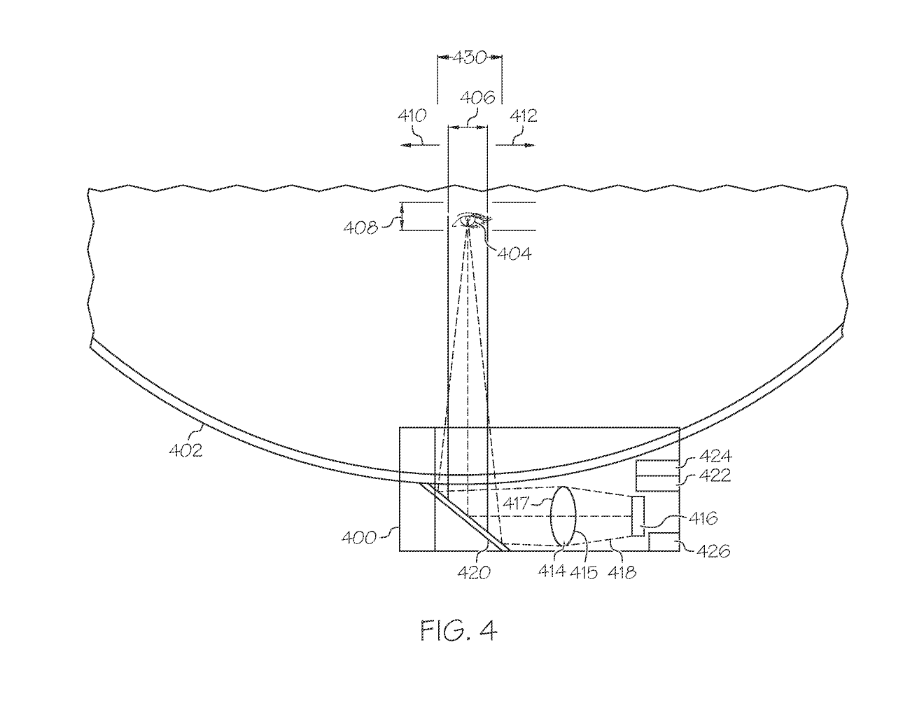

The processor 318 (and processor 422 of FIG. 4) may include or cooperate with an appropriate amount of memory (not shown), which can be realized as RAM memory, flash memory, EPROM memory, EEPROM memory, registers, a hard disk, a removable disk, a CD-ROM, or any other form of storage medium known in the art. In this regard, the memory can be coupled to the processor 318 such that the processor 318 (and processor 422 of FIG. 4) can read information from, and write information to, the memory. In the alternative, the memory may be integral to the processor 318 (and processor 422 of FIG. 4). In practice, a functional or logical module/component of the system described here might be realized using program code that is maintained in the memory. Moreover, the memory can be used to store data utilized to support the operation of the system, as will become apparent from the following description. While shown as being physically co-located with image source 316, other embodiments may involve additional physical separation between the various processing and memory components and the rest of the proximity display system.

No matter how processor 318 is specifically implemented, it is in operable communication with image source 316. Processor 318 is configured, in response to inputs from various sources of data such as protective suit status sensors, environmental sensors (sensing, for example, suit pressure, temperature, voltage, current and the like), and any number of wire-coupled or wirelessly-coupled sources of image data which are external to proximity display system 300 to selectively retrieve and process data from the one or more sources and to generate associated display commands. In response to the display commands, image source 316 selectively renders a display of various types of textual, graphic, video and/or iconic information. For simplifying purposes, the various textual, graphic, and/or iconic data generated by image source 316 may be referred to collectively as an “image.”

The image source 316 (and image source 416 of FIG. 4) may be implemented using any one of numerous known display devices suitable for rendering textual, graphic, and/or iconic information in a format viewable by the user. Non-limiting examples of such image sources include various light engine displays, organic LED displays (OLED, AMOLED), liquid crystal displays (LCD, AMLCD, LCOS), compact projection displays (e.g. DLP with etendue-enhancing screen), discrete elements, etc. The image source 316 (and image source 416 of FIG. 4) may additionally be secured or coupled to a housing or to a helmet by any one of numerous known technologies. It will be readily appreciated that while image source 316 (and image source 416 of FIG. 4) is depicted as a single image source, in practice it may include any combination of image sources of different types.

FIG. 4 is an expanded top down illustration providing detail of an exemplary embodiment providing a see-through reflector or combiner. Proximity display system 400 is shown coupled to protective bubble 402. Components making up the proximity display system 400 may be internal or external to protective bubble 402. An eye 404 is shown within a predetermined eyebox which is a volume having the dimensions length 408 and width 406 (alternatively, the eyebox may not be a “box” shape, and may be defined by a radius or diameter, or more generally as a volume having a desired form factor). As previously described, an optionally defined first zone 410 and second zone 412 are shown as regions on the left and right side of the predetermined eyebox, and may be optionally defined as various regions, and assigned unique priorities. Proximity display system 400 includes collimating lens 414 and an image source 416. An input surface 415 of the collimating lens 414 faces the image source 416, having unobscured access to images generated by the image source 416. Image light rays 418 (analogous to image light rays 202 in FIG. 2) are shown impinging on the input side of collimating lens 414; collimating lens 414 deflects the image light rays 418 such that the rays leaving its output surface 417 present a virtual image for potential viewing by eye 404. While the collimating lens 414 is depicted in FIG. 4 as a single lens, it may include a plurality of optical elements of various types, sizes, and shapes, for example lenses, mirrors, holograms, prisms, beamsplitters, waveguides, etc.

Combiner 420 is oriented to redirect the virtual image rays produced at the output surface 417 of the collimating lens. Combiner 420 may take any of numerous forms known in the art, such as flat or curved reflectors, multiple combiners, waveguide combiners, holographic combiners and so forth. FIG. 4 depicts combiner 420 redirecting the image at a substantially ninety degree angle; however various angles are supported by the embodiment. Combiner 420 preferably has a degree of transparency that would allow the viewer to view objects behind combiner 420, with the displayed image overlaid upon the see-through scene. Conformal matching of displayed image features with the see-through scene is also an option, though it would typically involve more stringent optimization of optical performance.

As in the embodiment shown in FIG. 3, Processor 422 receives data and instructions from memory 424 and eye detector 426, and determines commands and input for image source 416. Optionally, one or more user input devices may also be coupled to the processor to allow user modification of data parameters such as zone locations, dimensions and priorities. Optional user input may be verbal, textual, touch or gesture commands as well as the mechanical manipulation of keys or buttons. As previously described, eye detector 426 may include a camera and may be built into the proximity display or coupled to the proximity display, and eye detection may be performed using various combinations of currently available hardware and software. In response to data from the eye detector 426, processor 422 may optionally introduce a hysteresis effect into the blanking or modification of the display. For example, processor 422 may add a predetermined delay time before blanking the display after the eye leaves the eyebox.

Additionally, processor 422 may introduce a form of motion or spatial hysteresis in response to eye detector data and/or user input, for example by dynamically and temporarily resizing the predetermined eyebox in one or more dimensions (for example, to width 430) when the eye is detected within the predetermined eyebox (for example, within eyebox with width 406), thereby improving viewability of the display with the resized, larger, eyebox. The processor 422 may continue monitoring eye location data and determine whether the eye exits the resized eyebox, at which time the processor 422 may revert the eyebox dimensions back to the predetermined eyebox.

No matter how processor 422 is specifically implemented, it is in operable communication with image source 416. Processor 422 is configured, in response to inputs from various sources of data such as protective suit status sensors and environmental sensors (sensing, for example, suit pressure, temperature, voltage, current and the like), and any number of wire-coupled or wirelessly-coupled sources of image data which are external to proximity display system 400 to selectively retrieve and process data from the one or more sources and to generate associated display commands for the image source 416. In response, image source 416 selectively renders a display (referred to herein as the generated image or the modified generated image) of various types of textual, graphic, video, and/or iconic information.

Within each embodiment, the processor (such as processor 318 of FIG. 3 and processor 422 of FIG. 4) may continuously monitor environmental and safety data, suit pressure sensors, temperature sensors, voltage sensors, current sensors and the like. In response to the various inputs, the processor may generate appropriate commands for the image source to render or display various textual, graphic, and/or iconic data as described hereinabove.

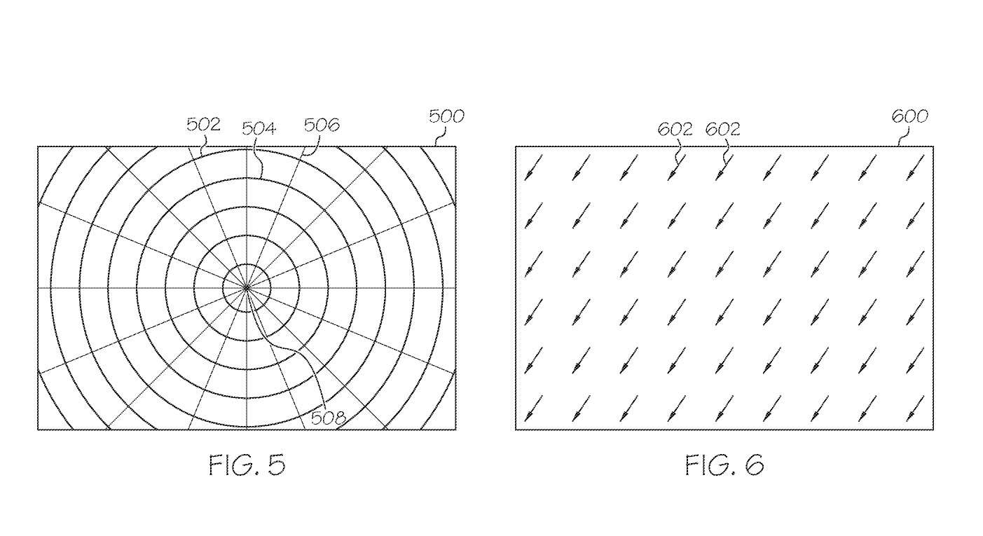

FIG. 5 is an illustration of a display 500 in which the generated image has been blanked and cueing information is displayed in accordance with an exemplary embodiment. Concentric circles, for example, circle 502 and circle 504 are shown. Additional cueing lines 506 that radiate from the center 508 of the cueing pattern may also be displayed. The exemplary cueing provides intuitive and effective directional guidance for the user to reposition his eye to the eyebox. As described hereinabove, cueing information may be displayed immediately after detection that the eye is not in the eyebox, or may be delayed, using temporal or spatial hysteresis. In response to detecting that the user's eye is back within the eyebox, the processor 422 may stop displaying the cueing information, in which case the virtual image reverts back to a representation of the generated image.

FIG. 6 is an illustration of a display 600 in which the generated image has been blanked and an alternate cueing method is displayed in accordance with an exemplary embodiment. Arrows 602 provide intuitive and effective directional guidance for the user to reposition his eye to the eyebox. The pointing direction of arrows 602 may be adjusted to indicate the direction the eye should move to approach the eyebox center or previously described “sweet spot”. As described hereinabove, cueing information may be displayed immediately after detection that the eye is not in the eyebox, or may be delayed, using hysteresis. In response to detecting that the user's eye is back within the eyebox, the processor 422 may stop displaying the cueing information, in which case the virtual image reverts back to a representation of the generated image. While FIG. 5 and FIG. 6 show dark cueing symbols on a light background, it may be preferable from a stray light perspective to configure the patterns as a dark background with lighter symbols superimposed on that background. Similar cueing patterns would be applicable to other embodiments, such as those previously described.

As described above, it is readily appreciated that the various components of a proximity display system may be of any shape or volume, material, transparency or orientation that is suitable to meet the environmental and design requirements. Additionally, individual components of a proximity display system may be placed within or without a housing, at any location on a helmet or support surface, and may be designed to operate with the right or left eye individually or placed centrally so that either eye may comfortably view the display.

Thus, a system and method for controlling a proximity display system by providing the ability to rapidly blank and un-blank the display is provided. The system and method enable blanking and un-blanking in response to the detected location of the viewer's eye. The system and method optionally provide the viewer with cueing information that directs the viewer's eye toward the eyebox in response to detecting that the viewer's eye is out of the eyebox. The system and method also provide the capability to override the reduced or otherwise modified eyebox behavior when desired, such as for the purposed of alerting the user to hazardous situations or other scenarios requiring attention.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A proximity display system, comprising:
a detector for detecting a location of an eye;
an image source for generating an image;
a processor coupled to the image source and detector, and configured to i) determine the location of the eye with respect to a predetermined eyebox, and ii) command the image source to modify the generated image depending on the detected location of the eye; and
an optical assembly oriented to create a virtual image based on the generated image.

2. The proximity display system of claim 1, wherein the optical assembly is configured to create the virtual image to appear to be focused at a predetermined distance when viewed from the predetermined eyebox.

3. The proximity display system of claim 1, wherein the processor is further configured to command the image source to blank the generated image in response to determining that the eye is not located within the predetermined eyebox.

4. The proximity display system of claim 3, wherein the processor is further configured to delay the blanking of the generated image by a predetermined delay time.

5. The proximity display system of claim 1, wherein the processor is further configured to i) enlarge the size of the predetermined eyebox in response to the determination that the eye is located within the predetermined eyebox, ii) determine when the eye is not located within the enlarged eyebox, and iii) revert the dimensions of the eyebox to the original size of the predetermined eyebox when the eye is not located within the enlarged eyebox.

6. (canceled)

7. The proximity display system of claim 1, wherein the processor is further configured to, when it is determined that the eye is not in the eyebox, i) determine a direction that the eye must move to be located within the predetermined eyebox, and ii) display cueing symbology indicative of the direction that the eye must move to be located within the predetermined eyebox.

8. The proximity display system of claim 2, further comprising a combiner oriented to redirect the unobscured virtual image rays toward the predetermined eyebox.

9. The proximity display system of claim 8, wherein the optical assembly comprises a collimating lens.

10. The proximity display system of claim 1, further comprising a source of user input data, wherein the user input data comprises one or more from the set including: verbal, textual, touch, gesture commands, and mechanical manipulation of keys or buttons; and wherein the processor is further configured to adjust eyebox dimensions based on the user input data.

11. The proximity display system of claim 10, wherein the processor is further configured to assign a region of space in proximity to the eyebox with a unique priority in response to user input data.

12. The proximity display system of claim 1, wherein the detector comprises a camera.

13. A proximity display system, comprising:
an image source for generating an image;
a lens coupled to the image source and oriented to produce a virtual image representative of the generated image and viewable from a predetermined eyebox;
a detector for detecting the location of an eye; and
a processor coupled to the image source and detector, and configured to i) command the image source to display the generated image, ii) determine the location of the eye with respect to the predetermined eyebox, iii) command the image source to modify the generated image depending on the detected location of the eye, and iv) command the image source to blank the generated image when the eye is not located within the predetermined eyebox.

14. The proximity display system of claim 13, wherein the processor is further configured to i) enlarge the size of the predetermined eyebox in response to the determination that the eye is located within the predetermined eyebox, ii) determine when the eye is not located within the enlarged eyebox, and iii) revert the dimensions of the eyebox to the original size of the predetermined eyebox when the eye is not located within the enlarged eyebox.

15. The proximity display system of claim 13, wherein the processor is further configured to display cueing symbology in response to determining that the eye is not located within the predetermined eyebox.

16. The proximity display system of claim 13, wherein the processor is further configured to delay the blanking of the generated image by a predetermined delay time.

17. The proximity display system of claim 13, further comprising a combiner oriented to redirect unobscured virtual image rays toward the predetermined eyebox.

18-20. (canceled)

21. The proximity display system of claim 3, wherein the processor is further configured to override a command to the image source to blank the generated image in response to a hazardous situation.

22. The proximity display system of claim 13, wherein the processor is further configured to override a command to the image source to blank the generated image in response to a hazardous situation.

23. The proximity display system of claim 13, comprising a source of user input data, wherein the user input data comprises one or more from the set including: verbal, textual, touch, gesture commands, and mechanical manipulation of keys or buttons; and wherein the processor is further configured to adjust eyebox dimensions based on the user input data.
